(19) United States
(12) Patent Application Publication
(10) Pub. No.: US 2026/0258821 A1
(43) Pub. Date: Sep. 3, 2026

(54) FLUID PRESSURE CIRCUIT

(71) Applicant: EAGLE INDUSTRY CO., LTD., Tokyo (JP)

(72) Inventor: Yoshiyuki SHIMADA, Tokyo (JP)

(21) Appl. No.: 18/840,067

(22) PCT Filed: Feb. 17, 2023
(86) PCT No.: PCT/JP2023/005749

§ 371 Date: Aug. 20, 2024

(30) Foreign Application Priority Data
Feb. 24, 2022 (JP) 2022-027084

(51) Int. Cl. F15B 13/02; E02F 9/22; F15B 21/14

(52) U.S. Cl. CPC F15B 13/022; F15B 13/026; F15B 21/14; E02F 9/2278; F15B 2211/4053; F15B 2211/465; F15B 2211/50572; F15B 2211/5151; F15B 2211/611; F15B 2211/625

(57) ABSTRACT

A fluid pressure circuit includes a fluid supply source and, an actuator device actuated by a fluid from the fluid supply source. A switching valve provided between the fluid supply source and the actuator device to switch flow passages and a flow diverter valve configured to divert at least some of the fluid, which flows from the fluid supply source to the main flow passage on a switching valve 4 side, to a diverted flow passage. The flow diverter valve is provided with a pressure compensation valve that variably adjusts an opening degree of the diverted flow passage according to a differential pressure between the main flow passage and the diverted flow passage to compensate for a flow rate to the diverted flow passage.

### TECHNICAL FIELD

The present invention relates to a fluid pressure circuit, for example, a fluid pressure circuit that controls a fluid actuator in response to an operation command.

### BACKGROUND ART

A fluid pressure circuit is used to control a fluid actuator in response to an operation command in an automobile, a construction machine, a cargo handling vehicle, an industrial machine, and the like. For example, a hydraulic excavator supplies a pressure fluid from a hydraulic pump to a cylinder device connected to a hydraulic circuit as the fluid pressure circuit, to extend and retract the cylinder device to drive a load.

An example of such a fluid pressure circuit is disclosed in Patent Citation 1. A fluid pressure circuit of Patent Citation 1 mainly includes a pump; a cylinder device; a switching valve connected between the pump and the cylinder device; and a flow diverter valve capable of diverting some of pressure oil, which flows from the pump to a main flow passage on a cylinder device side, to a diverted flow passage. When the switching valve is switched to an extension position by operating an operation lever, the pressure oil from the hydraulic pump is introduced into a bottom chamber of the cylinder device, and a rod extends from a cylinder. On the other hand, when the switching valve is switched to a retraction position by operating the operation lever of a remote control valve, the pressure oil from the hydraulic pump is introduced into a rod chamber of the cylinder device, and the rod retracts into the cylinder. Incidentally, when the switching valve is at a neutral position, the pressure oil from the hydraulic pump returns to a tank via the flow diverter valve and the switching valve, and the rod does not operate.

In addition, the flow diverter valve is a normally open electromagnetic proportional control valve. When the operation lever is at a neutral position or a retraction position, a spool of the flow diverter valve is at a neutral position, and the entire amount of pressure oil from the pump is supplied to the main flow passage on the cylinder device side. On the other hand, when the operation lever is operated to an extension position, the spool of the flow diverter valve is switched from the neutral position to a flow diversion position, and the pressure oil from the pump is supplied to the main flow passage on the cylinder device side and the diverted flow passage.

### CITATION LIST

### Patent Literature

Patent Citation 1: WO 2019/198579 A (Page 7, FIG. 7)

### SUMMARY OF INVENTION

### Technical Problem

In the fluid pressure circuit of Patent Citation 1, some of the pressure oil flowing from the pump to the main flow passage is diverted to a diverted flow passage side by the flow diverter valve, so that the flow rate of the pressure oil supplied to the switching valve can be adjusted. However, in the fluid pressure circuit as in Patent Citation 1, the pressure in the diverted flow passage may fluctuate, and when the pressure in the diverted flow passage becomes relatively higher than the pressure in the main flow passage, it becomes difficult for the pressure oil from the pump to flow to the diverted flow passage side, and the pressure oil is excessively supplied to a main flow passage on a switching valve side.

The present invention has been made in view of such problems, and an object of the present invention is to provide a fluid pressure circuit capable of suppressing excessive supply of a fluid to a main flow passage on a switching valve side.

### Solution to Problem

In order to solve the foregoing problems, a fluid pressure circuit according to the present invention is a fluid pressure circuit including: a fluid supply source; an actuator device actuated by a fluid from the fluid supply source; a switching valve provided between the fluid supply source and the actuator device to switch flow passages; and a flow diverter valve has a function of diverting at least some of the fluid, which flows from the fluid supply source to a main flow passage included in the flow passages and connected to the switching valve, to a diverted flow passage, wherein the flow diverter valve is provided with a pressure compensation valve that variably adjusts an opening degree of the diverted flow passage according to a differential pressure between the main flow passage and the diverted flow passage to compensate for a flow rate to the diverted flow passage. According to the aforesaid features of the present invention, since the pressure compensation valve variably adjusts the opening degree of the diverted flow passage according to the differential pressure between the main flow passage and the diverted flow passage to compensate for the flow rate to the diverted flow passage, the excessive supply of the fluid to the main flow passage on the switching valve side during actuation of the switching valve can be suppressed.

It may be preferable that the pressure compensation valve is a pilot valve operated by a pilot pressure of the main flow passage and the diverted flow passage. According to this preferable configuration, since the pressure compensation valve is operated by the pilot pressure, the structure of the pressure compensation valve can be simplified, and the flow rate to the diverted flow passage can be reliably compensated.

It may be preferable that a housing of the flow diverter valve and a housing of the pressure compensation valve are integrally formed. According to this preferable configuration, the flow diverter valve and the pressure compensation valve can be made compact.

It may be preferable that the flow diverter valve includes the housing provided with a first communication passage communicating a flow passage between the fluid supply source and the flow diverted valve to the main flow passage via the pressure compensation valve, and a second communication passage communicating the flow passage between the fluid supply source and the flow diverted valve to the diverted flow passage via the pressure compensation valve, and a valve body that adjusts an opening degree of the second communication passage. According to this preferable configuration, since the valve body is not provided in the first communication passage leading from the fluid supply source to the pressure compensation valve, the fluid to the main flow passage is allowed to pass with small loss.

It may be preferable that an auxiliary machine actuated by the fluid flowing through the diverted flow passage is provided in the diverted flow passage. According to this preferable configuration, the fluid diverted to the diverted flow passage can be used to actuate the auxiliary machine such as a regenerative drive source or an accumulator.

### BRIEF DESCRIPTION OF DRAWINGS

FIG. 1 is a view illustrating a wheel loader into which a hydraulic circuit as a fluid pressure circuit according to a first embodiment of the present invention is built.

FIG. 2 is a view illustrating the hydraulic circuit in the first embodiment.

FIG. 3 is a graph illustrating a relationship between an operation lever stroke and a pilot secondary pressure in the first embodiment.

FIG. 4 is a graph illustrating a relationship between a spool stroke and an opening area of a switching valve in the first embodiment in the first embodiment.

FIG. 5 is a graph illustrating a relationship between the operation lever stroke and the extension speed of a rod in the first embodiment.

FIG. 6 is a graph illustrating an output characteristic of a generator according to the rotation speed of a regenerative motor in the first embodiment.

FIG. 7 is a graph illustrating a relationship between an electric signal from a controller and a priority flow rate of a flow diverter valve device in the first embodiment.

FIG. 8 is a schematic view illustrating the state of the flow diverter valve device when a main hydraulic pump is stopped and a flow diverter valve is not energized in the first embodiment.

FIG. 9 is a schematic view illustrating the state of the flow diverter valve device when the main hydraulic pump is operated and the flow diverter valve is not energized in the first embodiment.

FIG. 10 is a schematic view illustrating a state where the flow diverter valve is energized from the state of FIG. 9 when there is almost no differential pressure between a main flow passage and a diverted flow passage.

FIG. 11A is a schematic view illustrating the initial state of energization where the flow diverter valve is energized from the state of FIG. 9 when the pressure in the diverted flow passage is higher than the pressure in the main flow passage, and FIG. 11B is a schematic view illustrating a state where a pressure compensation valve is operated from the state of FIG. 11A.

FIG. 12A is a schematic view illustrating the initial state of energization where the flow diverter valve is energized from the state of FIG. 9 when the pressure in the diverted flow passage is lower than the pressure in the main flow passage, and FIG. 12B is a schematic view illustrating a state where the pressure compensation valve is operated from the state of FIG. 12A.

FIG. 13 is a graph illustrating a relationship between the spool stroke of the switching valve and the priority flow rate in the first embodiment.

FIG. 14 is a view illustrating a hydraulic circuit as a fluid pressure circuit according to a second embodiment of the present invention.

FIG. 15 is a graph illustrating a relationship between a spool stroke and an opening area of a switching valve in the second embodiment.

### DESCRIPTION OF EMBODIMENTS

Modes for implementing a fluid pressure circuit according to the present invention will be described below based on embodiments.

### First Embodiment

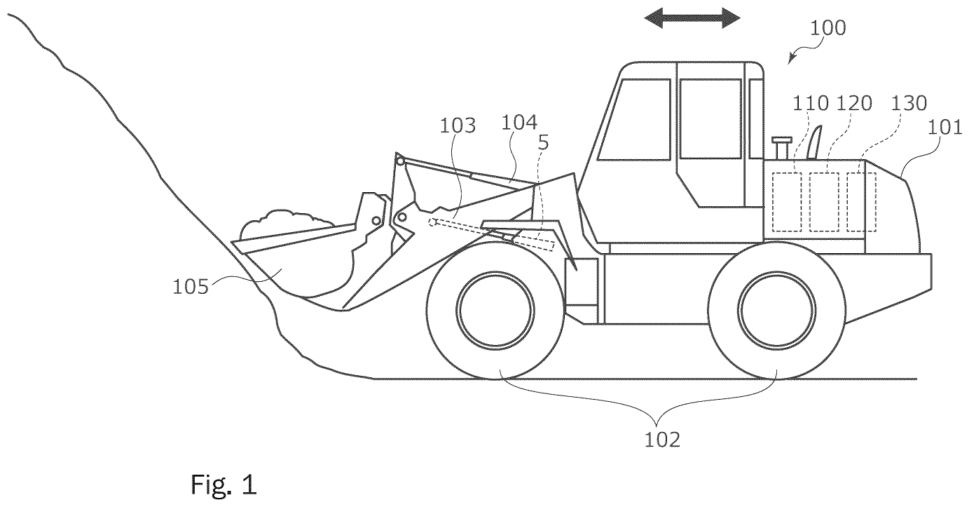

A fluid pressure circuit according to a first embodiment of the present invention will be described with reference to FIGS. 1 to 13.

A hydraulic circuit as the fluid pressure circuit according to the first embodiment is a hydraulic circuit that controls the stroke of a cylinder device in response to an operation command in a work machine, a construction machine, a cargo handling vehicle, an automobile, or the like, and is built into, for example, the powertrain of a wheel loader 100 illustrated in FIG. 1. The wheel loader 100 mainly includes a vehicle body 101, wheels 102 for traveling, a work arm 103, a hydraulic cylinder 104, and a bucket 105 for taking gravel or the like. The vehicle body 101 is provided with a machine 110 such as an engine, a fluid circuit 120 for traveling, the hydraulic cylinder 104, and a hydraulic circuit 130 for work that drives a hydraulic cylinder 5 as an actuator device and the like.

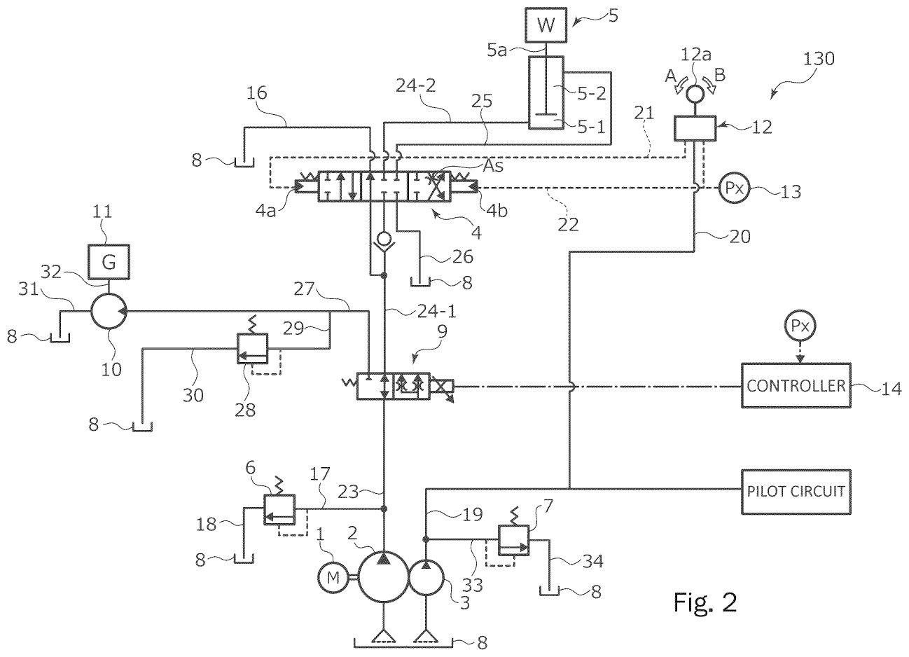

As illustrated in FIG. 2, the hydraulic circuit 130 mainly includes a main hydraulic pump 2 as fluid supply source driven by a drive mechanism 1 such as an engine or an electric motor; a pilot hydraulic pump 3; a switching valve 4; the hydraulic cylinder 5; a relief valve 6; a relief valve 7; a tank 8; a flow diverter valve device 9; a regenerative motor 10 and a generator 11 as auxiliary machines; a remote control valve 12; a pressure sensor 13; a controller 14; and oil passages 16 to 34. Incidentally, the regenerative motor 10 and the generator 11 are provided as examples of auxiliary machines; however, the present invention is not limited thereto.

The main hydraulic pump 2 is a fixed capacity pump, is coupled to the drive mechanism 1 such as an internal combustion engine, and is rotated by power from the drive mechanism 1, to supply pressure oil to a downstream side through the oil passage 23.

The pressure oil discharged from the main hydraulic pump 2 passes through the oil passage 23, and flows into the switching valve 4 via the flow diverter valve device 9 to be described later and the oil passage 24-1 as a main flow passage. The switching valve 4 is a 6-port, 3-position open center switching valve, and in a state where a spool is at a neutral position, the entire amount of pressure oil discharged from the main hydraulic pump 2 flows to the tank 8 through the oil passage 16.

In addition, in a main circuit including the main hydraulic pump 2, in order to prevent oil devices in the circuit from being damaged due to the oil in the circuit becoming blocked and the pressure becoming abnormally high when a rod 5a of the hydraulic cylinder 5 has reached an extension termination or a retraction termination or a sudden load is applied to the hydraulic cylinder 5, the relief valve 6 is installed, and the high-pressure oil is discharged into the tank 8 through the oil passages 17 and 18.

Next, similarly to the main hydraulic pump 2, the pilot hydraulic pump 3 is coupled to the drive mechanism 1 and is operated by power from the drive mechanism 1, to supply the pressure oil to a downstream side through the oil passage 19. Here, some of the pressure oil supplied to the downstream side through the oil passage 19 is supplied to the remote control valve 12 through the oil passage 20.

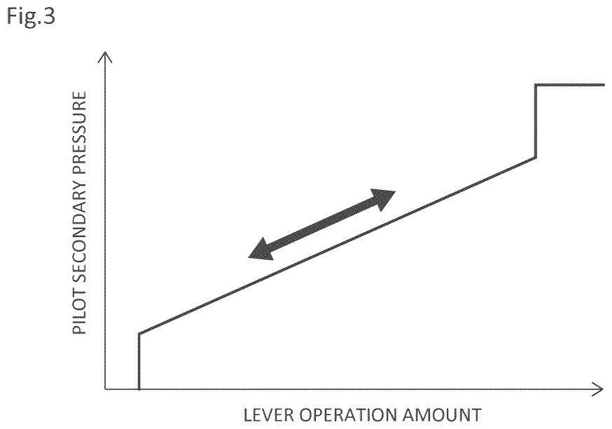

The remote control valve 12 is a variable pressure-reducing valve, and controls the extension position (extension amount) or retraction position (retraction amount) of the rod 5a by supplying a pilot secondary pressure, which is proportional to the operation lever stroke of an operation lever 12a as illustrated in FIG. 3, to a signal port 4a or a signal port 4b of the switching valve 4 through the pilot signal oil passage 21 or the pilot signal oil passage 22 through operating the rod 5a of the hydraulic cylinder 5 in an extension direction A or a retraction direction B using the operation lever 12a. Incidentally, an operation amount of the operation lever 12a is substantially equivalent to a stroke of the operation lever 12a, and is referred to as an operation lever stroke. In addition, in the present invention, an operation in the retraction direction B is referred to as a predetermined operation.

When the operation lever 12a of the remote control valve 12 is operated in the extension direction A and the switching valve 4 is switched to an extension position, the pressure oil from the main hydraulic pump 2 flows into a bottom chamber 5-1 of the hydraulic cylinder 5 through the oil passage 23, the flow diverter valve device 9, the oil passage 24-1, the switching valve 4, and the oil passage 24-2, and the oil in a rod chamber 5-2 passes through the oil passage 25, and is discharged into the tank 8 further through the oil passage 26 via the switching valve 4. Accordingly, the rod 5a of the hydraulic cylinder 5 actuates in the extension direction.

On the other hand, when the operation lever 12a of the remote control valve 12 is operated in the retraction direction B and the switching valve 4 is switched to a retraction position, the pressure oil from the main hydraulic pump 2 flows into the rod chamber 5-2 of the hydraulic cylinder 5 through the oil passage 23, the flow diverter valve device 9, the oil passage 24-1, the switching valve 4, and the oil passage 25, and the oil in the bottom chamber 5-1 passes through the oil passage 24-2, and is discharged into the tank 8 further through the oil passage 26 via the switching valve 4. Accordingly, the rod 5a of the hydraulic cylinder 5 actuates in the retraction direction.

As illustrated in FIG. 3, the remote control valve 12 outputs a pilot secondary pressure that increases proportionally with an increase in the operation lever stroke of the operation lever 12a of the remote control valve 12. The switching valve 4 is configured such that the spool strokes substantially in proportion to the pilot secondary pressure of the remote control valve 12.

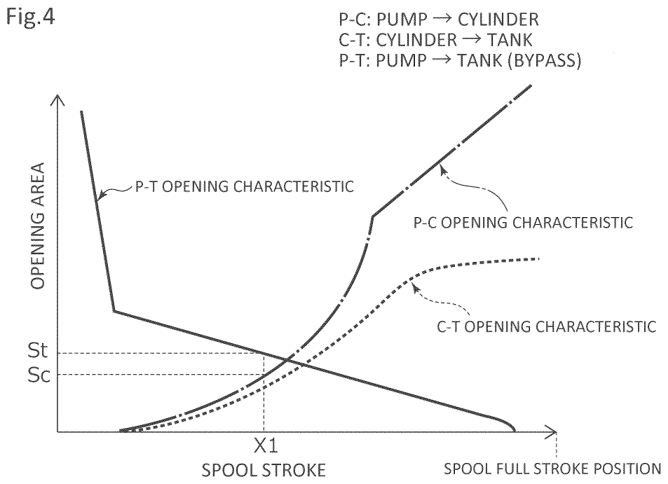

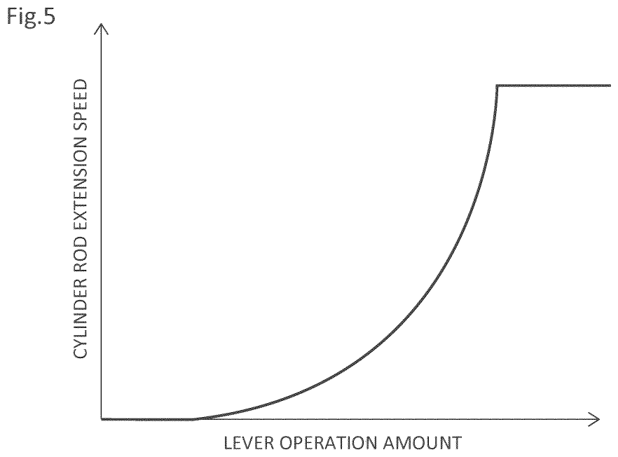

As illustrated in FIG. 4, since the switching valve 4 has opening characteristics in which a P-C (pump→cylinder) opening amount increases according to the spool stroke, whereas a P-T (pump→tank) opening amount decreases, the oil amount of the pressure oil supplied to the hydraulic cylinder 5 increases with an increase in the P-C (pump→cylinder) opening amount, and as illustrated in FIG. 5, the actuation speed of the rod 5a of the hydraulic cylinder 5 increases. Namely, the rod speed can be controlled according to the operation lever stroke of the operation lever 12a of the remote control valve 12.

Incidentally, when a weight W acts on the hydraulic cylinder 5 in the direction of gravity as illustrated in FIG. 2, the rod speed is predominantly controlled by a C-T opening (cylinder >tank) of FIG. 4. A variable throttle As is provided in a flow passage connecting the oil passage 24-1 and the oil passage 26 of the switching valve 4, and the flow rate is throttled by the variable throttle As, and the actuation speed of the rod 5a due to the weight W can be slowed down.

In addition, since a P-T (pump→tank) opening area St rapidly decreases from a fully open state in a region where a spool stroke X1 with reference to the neutral position of the switching valve 4 is relatively small, namely, a P-C (pump→cylinder) opening area Sc is small, when the entire amount of pressure oil from the main hydraulic pump 2 is supplied to the switching valve 4, heat is generated inside the switching valve 4, and a spool bore portion of a valve body or the spool undergoes local thermal expansion, thereby causing spool stuck, so to speak, thermal shock or the like, which is a risk.

In the present embodiment, in a case where the spool stroke X1 of the switching valve 4 is relatively small, some of the pressure oil from the main hydraulic pump 2 is diverted to an oil passage 27 side as a diverted flow passage by the flow diverter valve device 9 (refer to FIG. 2). Incidentally, a configuration of the flow diverter valve device 9 will be described later.

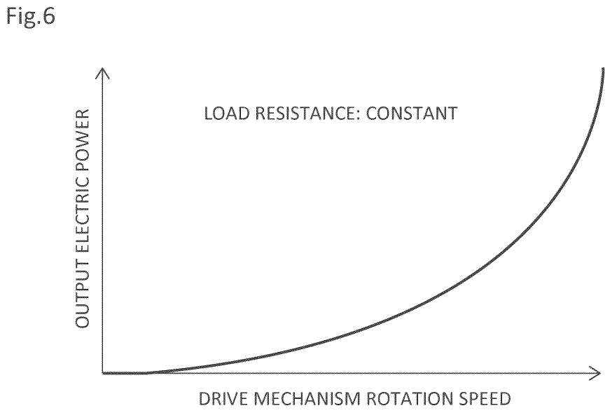

Returning to FIG. 2, the regenerative motor 10 is connected to the oil passage 27. The regenerative motor 10 is connected to the tank 8 via the oil passage 31, and is connected to the generator 11 via a coupling portion 32. The generator 11 outputs electric power with an output characteristic as illustrated in FIG. 6 according to the rotation speed of a drive mechanism such as the regenerative motor 10. In addition, in a case where the spool stroke X1 of the switching valve 4 is relatively large, when the amount of electricity generated by the generator 11 has reached an allowable electricity storage amount of an electricity storage device, the electric signal from the controller 14 to a flow diverter valve 91 to be described later is cut off, so that the flow of the pressure oil into the regenerative motor 10 is cut off, and the generator 11 is stopped not to generate electricity.

In addition, the oil passage 29 is diverted from the oil passage 27, and a relief valve 28 is connected to the oil passage 27 via the diverted oil passage 29. When abnormally high pressure occurs in the oil passage 27, the relief valve 28 actuates and the high-pressure oil is discharged into the tank 8 via the oil passage 30.

In addition, in a pilot circuit including the pilot hydraulic pump 3, the relief valve 7 is installed to control a maximum pressure in the circuit, and when the lever of the remote control valve 12 is in neutral, the pressure oil is discharged into the tank 8 through the oil passage 33 and the oil passage 34.

In addition, the pressure sensor 13 is installed on the pilot signal oil passage 22, and when the operation lever 12a of the remote control valve 12 is operated in the retraction direction B and the pilot secondary pressure occurs in the pilot signal oil passage 22, an electric signal is input to the controller 14 from the pressure sensor 13.

When the electric signal is input to the controller 14, an electric signal is output to the flow diverter valve 91 from an arithmetic circuit built into the controller 14 in advance, and the flow diverter valve 91 is switched to a position where the flow passage is diverted to the oil passage 24-1 and the oil passage 27.

When the electricity storage device has not reached the allowable electricity storage amount, the controller 14 controls the flow diverter valve 91 to be switched at the same time that the switching valve 4 is switched. The flow diverter valve 91 is switched to cause some of the pressure oil to flow into the regenerative motor 10 through the oil passage 27 via the flow diverter valve 91, so that the regenerative motor 10 rotates and electricity is generated by the generator 11. The oil that has passed through the regenerative motor 10 is discharged into the tank 8 via the oil passage 30.

The flow diverter valve device 9 is a pressure-compensated electromagnetic proportional control type flow rate adjustment valve capable of variably diverting the pressure oil to the oil passage 27 side in response to an electric signal from the controller 14. In other words, the flow diverter valve device 9 adjusts the flow rate of the pressure oil (hereinafter, also referred to as a priority flow rate) diverted to the oil passage 27 side.

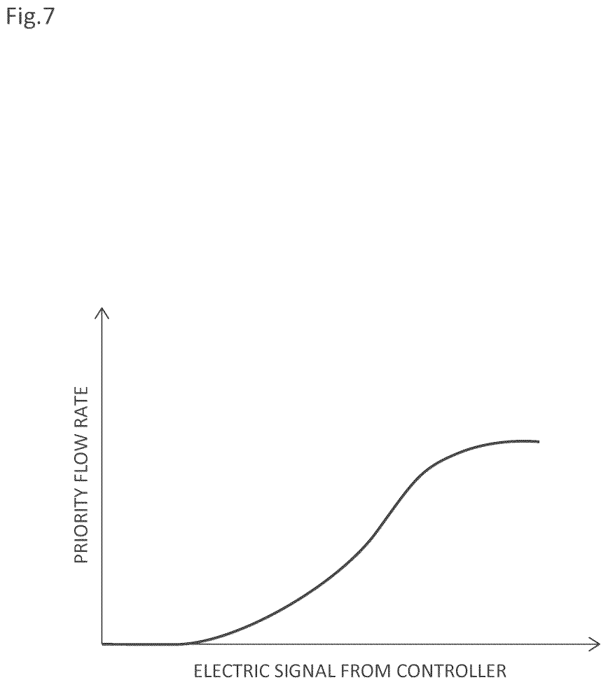

Incidentally, the flow diverter valve device 9 has a flow rate control characteristic as illustrated in FIG. 7. When no electric signal is input to the flow diverter valve 91 from the controller 14, the priority flow rate to the oil passage 27 side is zero, and the priority flow rate can increase or decrease in proportion to an electric signal from the controller 14.

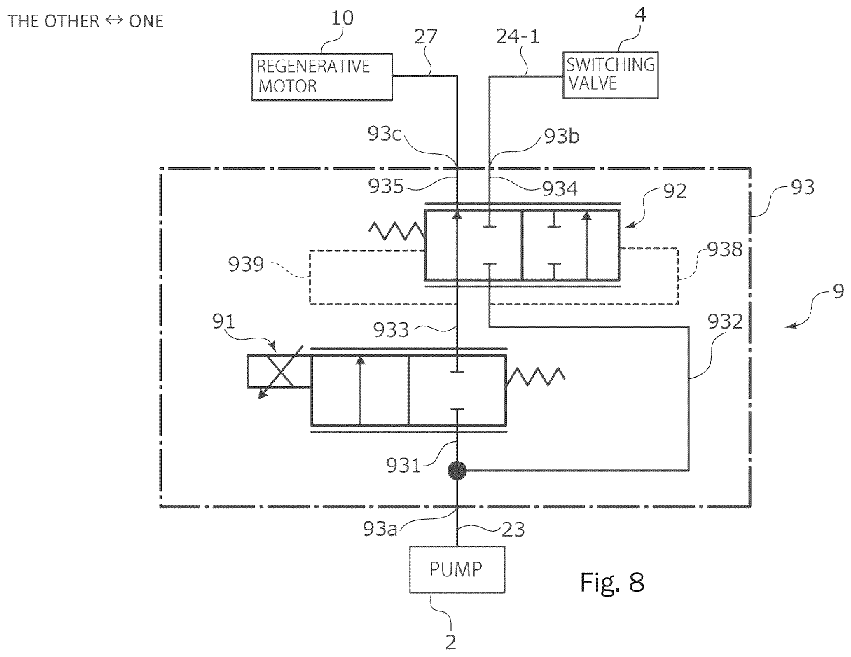

As illustrated in FIG. 8, the flow diverter valve device 9 mainly includes the flow diverter valve 91; a pressure compensation valve 92; and a housing 93 that accommodates the flow diverter valve 91 and the pressure compensation valve 92. Incidentally, FIG. 8 illustrates the state of the flow diverter valve device 9 when the main hydraulic pump 2 is stopped and the flow diverter valve 91 is not energized. Furthermore, hereinafter, for convenience of description, the right side of the drawing sheet of FIG. 8 and the left side of the drawing sheet may be referred to as one side and the other side, respectively.

The flow diverter valve 91 is a 2-port, 2-position normally closed electromagnetic proportional throttle valve, and is a spool type valve. The flow diverter valve 91 is at a neutral position where a spool that is a valve body is biased to the other side in the state of FIG. 8.

The pressure compensation valve 92 is a 4-port, 2-position pilot valve that is operated by pilot pressure of the oil passage 24-1 and the oil passage 27, and is a spool type valve. The pressure compensation valve 92 is at a neutral position where a spool that is a valve body is biased to the one side in the state of FIG. 8.

The housing 93 is provided with a pump-side port 93a, a switching valve-side port 93b, a regenerative motor-side port 93c, flow passages 931 to 935, and pilot flow passages 938 and 939. The pump-side port 93a is connected to the oil passage 23. The switching valve-side port 93b is connected to the oil passage 24-1. The regenerative motor-side port 93c is connected to the oil passage 27.

The flow passage 931 extends from the pump-side port 93a to the flow diverter valve 91. The flow passage 932 is diverted from the flow passage 931, and extends to the pressure compensation valve 92. The flow passage 933 extends to communicate the flow diverter valve 91 and the pressure compensation valve 92. The flow passage 934 extends from the pressure compensation valve 92 to the switching valve-side port 93b. The flow passage 935 extends from the pressure compensation valve 92 to the regenerative motor-side port 93c.

The flow passage 931, the flow passage 932, and the flow passage 934 function as a first communication passage that can communicate the oil passage 23 and the oil passage 24-1 via the pressure compensation valve 92. In addition, the flow passage 931, the flow passage 933, and the flow passage 935 function as a second communication passage that can communicate the oil passage 23 and the oil passage 27 via the pressure compensation valve 92.

The pilot flow passage 938 is connected to one side end portion of the pressure compensation valve 92 from the flow passage 932. The pilot flow passage 939 is connected to the other side end portion of the pressure compensation valve 92 from the flow passage 933.

When the flow diverter valve 91 is at the neutral position, the flow passage 931 and the flow passage 933 are out of communication. In addition, when the pressure compensation valve 92 is at the neutral position, the flow passage 932 and the flow passage 934 are out of communication, and the flow passage 933 and the flow passage 935 are in communication in a fully open state.

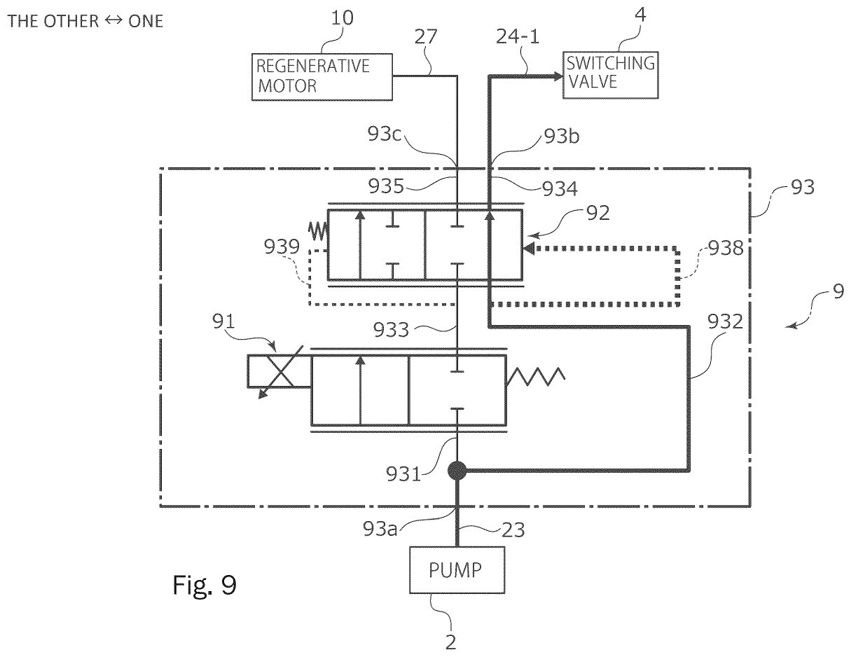

As illustrated in FIG. 9, when the main hydraulic pump 2 operates from the state of FIG. 8, the pressure oil from the main hydraulic pump 2 flows into the pilot flow passage 938 through the flow passage 932, and the pressure in the pilot flow passage 938 increases, so that the pressure compensation valve 92 is switched to a switching position.

When the pressure compensation valve 92 is at the switching position, the flow passage 932 and the flow passage 934 communicate with each other in a fully open state (namely, the pressure oil can pass through the first communication passage), and the flow passage 933 and the flow passage 935 become out of communication. Therefore, in a state where the main hydraulic pump 2 operates and the flow diverter valve 91 is not energized, the entire amount of pressure oil discharged from the main hydraulic pump 2 is supplied to the switching valve 4.

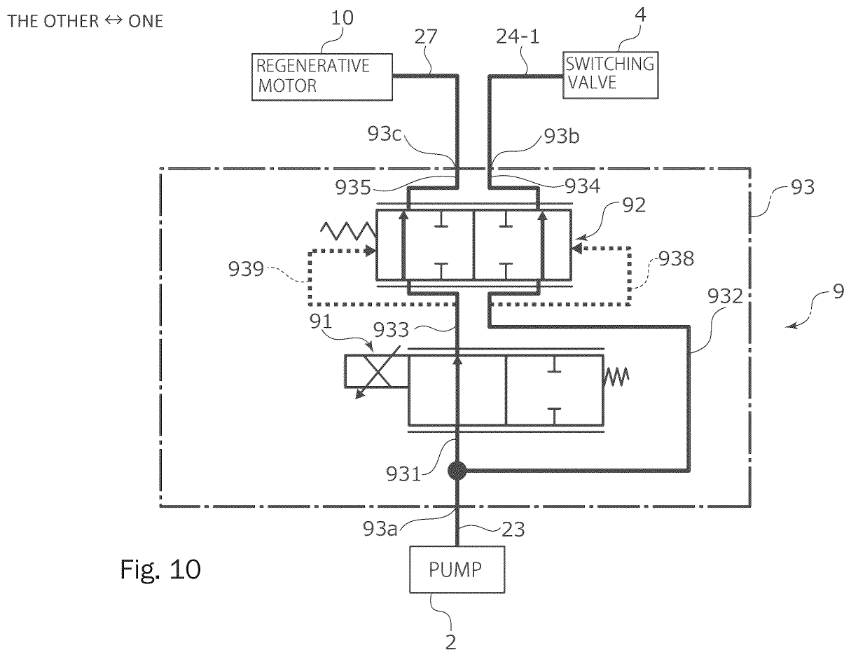

Next, a mode when the flow diverter valve 91 is energized from the state of FIG. 9 will be described using FIG. 10. Incidentally, in FIG. 10, a mode in which there is almost no differential pressure between the pressure in the oil passage 24-1 and the pressure in the oil passage 27 will be described. Furthermore, in FIGS. 10 to 12, control of the flow diverter valve device 9 in a region where the spool stroke X1 of the switching valve 4 is relatively small, namely, the P-C (pump→cylinder) opening area Sc is small will be described.

As illustrated in FIG. 10, when the flow diverter valve 91 is energized from the state of FIG. 9 and the flow diverter valve 91 is set to the switching position, the flow passage 931 and the flow passage 933 communicate with each other, and the pressure oil flows into the pilot flow passage 939, so that the pressure acting on the pressure compensation valve 92 is balanced out and the pressure compensation valve 92 is disposed at a position between the neutral position and the switching position.

When the pressure compensation valve 92 is disposed at a position between the neutral position and the switching position, the flow passage 932 and the flow passage 934 communicate with each other, and the flow passage 933 and the flow passage 935 communicate with each other (namely, the pressure oil can pass through the second communication passage), so that the pressure oil discharged from the main hydraulic pump 2 is diverted to the switching valve 4 and the regenerative motor 10.

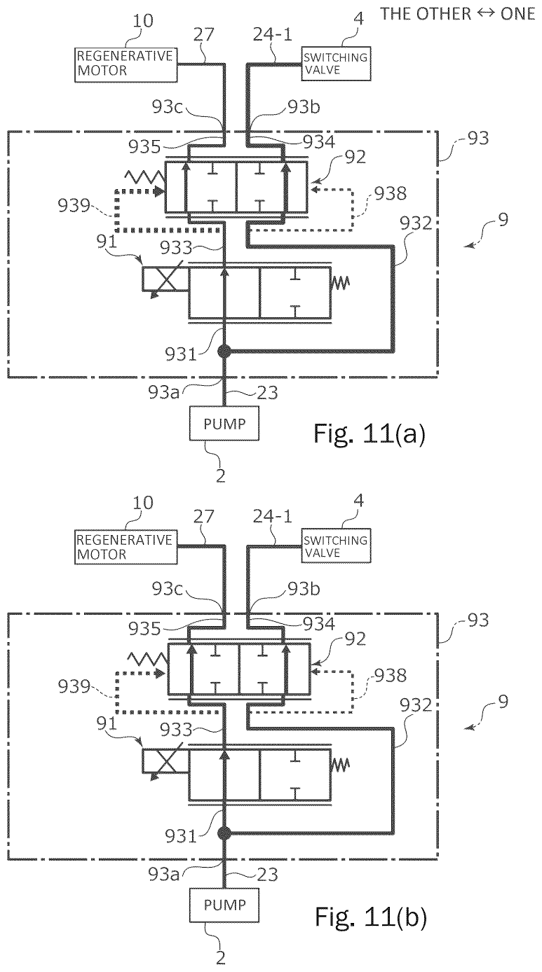

Next, a mode in which the flow diverter valve 91 is energized from the state of FIG. 9 when the pressure in the oil passage 27 is higher than the pressure in the oil passage 24-1 will be described using FIG. 11.

As illustrated in FIG. 11A, when the pressure in the oil passage 27 is higher than the pressure in the oil passage 24-1, the pressure in the pilot flow passage 938 becomes lower than the pressure in the pilot flow passage 939.

Accordingly, as illustrated in FIG. 11B, the spool of the pressure compensation valve 92 moves slightly toward the one side compared to the state of FIG. 11A to throttle an opening portion that communicates the flow passage 932 and the flow passage 934, and to widen an opening portion that communicates the flow passage 933 and the flow passage 935, so that a flow rate flowing to the regenerative motor 10 can be ensured.

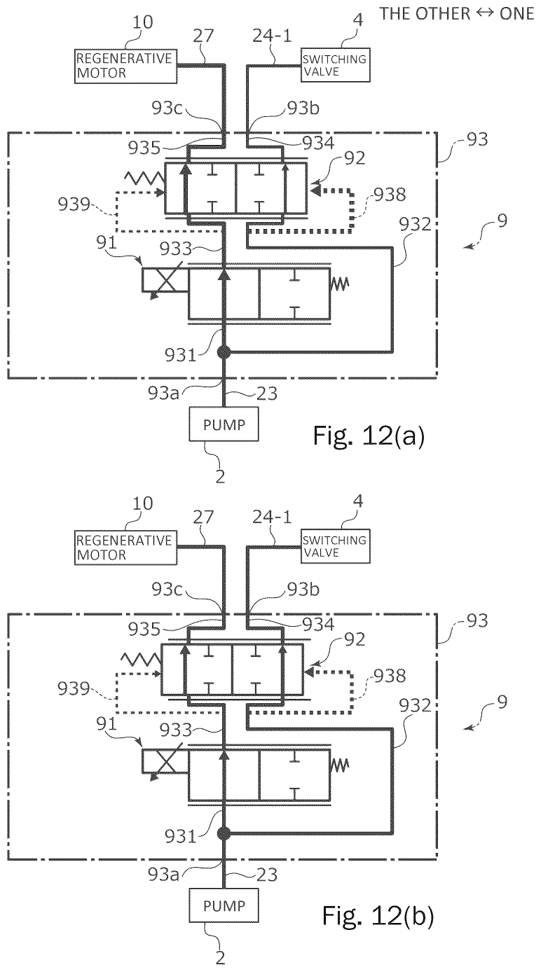

Next, a mode in which the flow diverter valve 91 is energized from the state of FIG. 9 when the pressure in the oil passage 27 is lower than the pressure in the oil passage 24-1 will be described using FIG. 12.

As illustrated in FIG. 12A, when the pressure in the oil passage 27 is lower than the pressure in the oil passage 24-1, the pressure in the pilot flow passage 938 becomes higher than the pressure in the pilot flow passage 939.

Accordingly, as illustrated in FIG. 12B, the spool of the pressure compensation valve 92 moves slightly toward the other side compared to the state of FIG. 12A to throttle the opening portion that communicates the flow passage 933 and the flow passage 935, and to widen the opening portion that communicates the flow passage 932 and the flow passage 934, so that a flow rate flowing to the switching valve 4 can be ensured.

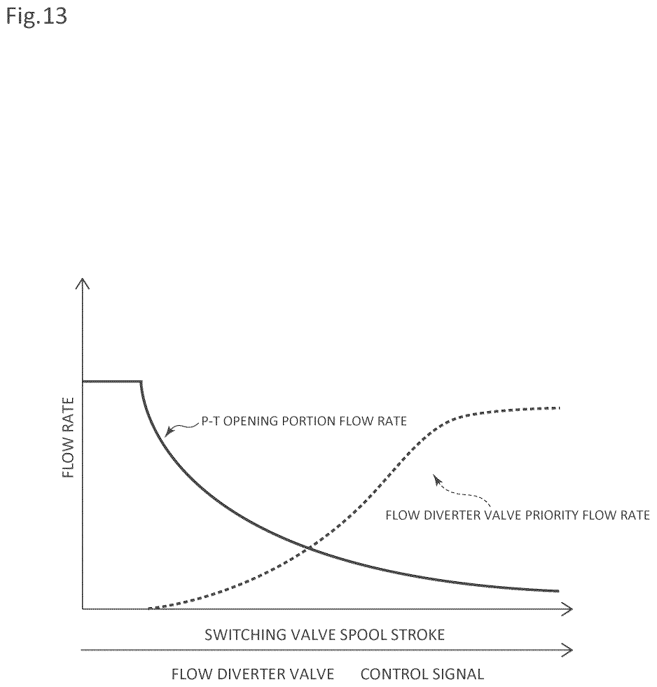

As illustrated in FIG. 13, in a region where the spool stroke X1 of the switching valve 4 is relatively small, namely, the P-T opening is narrow, most of a pump flow rate Q is controlled to flow to a priority circuit on the oil passage 27 side via the flow diverter valve device 9. In addition, although not illustrated, the priority flow rate to the oil passage 27 side is controlled to gradually decrease as the P-C opening widens. Accordingly, electricity can be generated using the regenerative motor 10 and generator 11 provided in the priority circuit, stored in the electricity storage device, and used as electric energy, and the generation of excessive heat inside the switching valve 4 can be avoided.

As described above, since in the flow diverter valve device 9, the pressure compensation valve 92 is provided on a downstream side of the flow diverter valve 91, and the pressure compensation valve 92 variably adjusts the opening degrees of the oil passage 24-1 and the oil passage 27 according to a differential pressure between the oil passage 24-1 on a switching valve 4 side and the oil passage 27 on a regenerative motor 10 side to compensate for flow rates to the oil passage 24-1 and the oil passage 27, the excessive supply of the oil to the oil passage 24-1 or the insufficient supply of the oil to the oil passage 24-1 during actuation of the switching valve 4 can be suppressed.

In addition, since the pressure compensation valve 92 is a pilot valve that is operated by the pilot pressure of the oil passage 24-1 and the oil passage 27, the structure of the pressure compensation valve 92 can be simplified without need to separately prepare means for detecting a differential pressure between the oil passage 24-1 and the oil passage 27, and the flow rate to the oil passage 27 and the flow rate to the oil passage 24-1 can be reliably compensated.

In addition, since the flow diverter valve 91 and the pressure compensation valve 92 are disposed in the same housing 93, the flow diverter valve 91 and the pressure compensation valve 92 can be made compact.

In addition, the housing 93 is provided with the flow passages 932 and 934 that communicate the oil passage 23 on a main hydraulic pump 2 side and the oil passage 24-1 via the pressure compensation valve 92, and the flow passages 933 and 935 that can communicate the oil passage 23 and the oil passage 27 via the pressure compensation valve 92, and the flow diverter valve device 9 is configured by disposing the flow diverter valve 91 to adjust the opening degree of the flow passage 933. According to this configuration, since the flow diverter valve 91 is not provided in the flow passage 932 leading from the main hydraulic pump 2 to the pressure compensation valve 92, the pressure oil to the oil passage 24-1 is allowed to pass with small loss.

In addition, since the regenerative motor 10 that is actuated by the oil flowing through the oil passage 27 is provided in the oil passage 27, the regenerative motor 10 can be driven using the oil diverted to the oil passage 27, and electricity can be generated by the generator 11.

### Second Embodiment

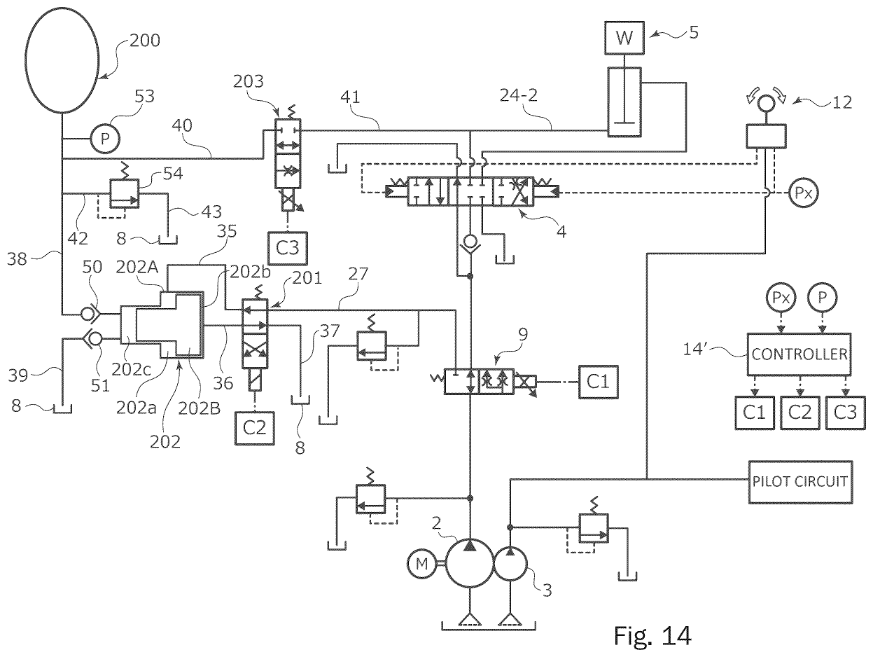

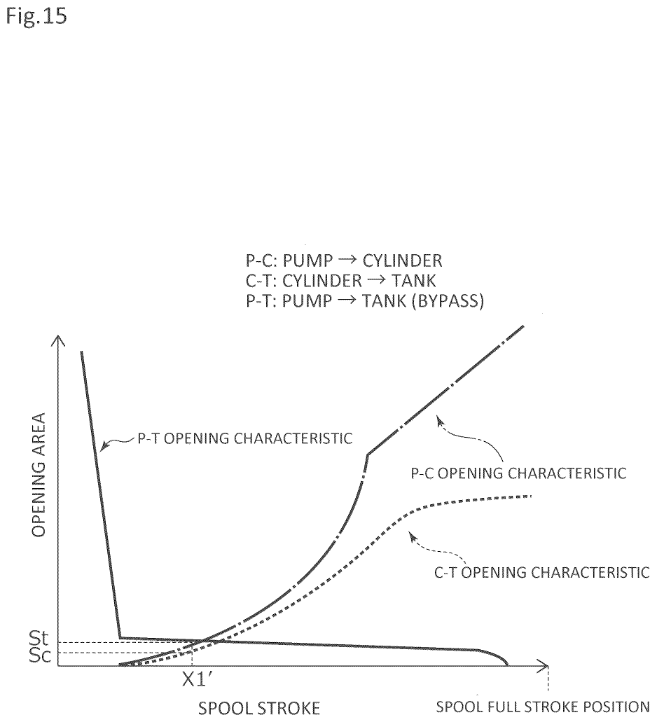

Next, a fluid pressure circuit according to a second embodiment of the present invention will be described with reference to FIGS. 14 and 15. Incidentally, the description of configurations that are the same as and overlap with the configurations of the above-described embodiment will be omitted.

As illustrated in FIG. 14, the hydraulic circuit of the second embodiment differs from the first embodiment in that the auxiliary machine is an accumulator 200 and in a configuration around the accumulator 200, and has the same configuration in other respects.

An electromagnetic switching valve 201 is connected to the oil passage 27. The electromagnetic switching valve 201 is a 4-port, 2-position electromagnetic switching valve, and is switched by receiving an electric signal from a controller 14′ via a signal line C2.

Oil passages 35, 36, and 37 extend to the electromagnetic switching valve 201. The oil passage 35 communicates with an oil chamber 202a of a pressure booster 202, and the oil passage 36 communicates with an oil chamber 202b on a back side of the pressure booster 202. In addition, the oil passage 37 is connected to the tank 8.

The pressure booster 202 is configured such that a piston 202B is enclosed in a casing 202A. The casing 202A and the piston 202B include respective large-diameter portions and respective small-diameter portions. Peripheral walls of the large-diameter portions slide against each other, and peripheral walls of the small-diameter portions slide against each other. In the pressure booster 202, according to the so-called Pascal's theorem, the pressure in an oil chamber 202c on a front side is increased in proportion to the ratio of cross-sectional areas thereof by the load pressure in the oil chamber 202b on the back side.

In a state where a solenoid of the electromagnetic switching valve 201 is demagnetized, the pressure oil diverted to the oil passage 27 by the flow diverter valve device 9 is introduced into the oil chamber 202a of the pressure booster 202 through the electromagnetic switching valve 201 and the oil passage 35, the oil in the oil chamber 202b is led out to the tank 8 through the oil passage 36, the electromagnetic switching valve 201, and the oil passage 37, and the piston 202B is disposed at a retraction end position.

When the solenoid of the electromagnetic switching valve 201 is magnetized, the pressure oil flowing through the oil passage 27 is introduced into the oil chamber 202b through the electromagnetic switching valve 201 and the oil passage 36, and the oil in the oil chamber 202a is led out to the tank 8 through the oil passage 35, the electromagnetic switching valve 201, and the oil passage 37, so that the piston 202B moves in an extension direction. Accordingly, the oil in the oil chamber 202c is accumulated in the accumulator 200 through a check valve 50 and an oil passage 38.

Next, when the solenoid of the electromagnetic switching valve 201 is demagnetized, the solenoid is returned to the original position by a spring of the electromagnetic switching valve 201, the pressure oil flowing through the oil passage 27 is introduced into the oil chamber 202a, and the oil in the oil chamber 202b is discharged into the tank 8, so that the piston 202B moves in a retraction direction. Accordingly, the oil in the tank 8 is introduced into the oil chamber 202c through an oil passage 39 and a check valve 51.

Due to the piston 202B being reciprocated by repeatedly magnetizing and demagnetizing the solenoid of the electromagnetic switching valve 201 as described above, the low-pressure oil flows into the oil chamber 202c from the tank 8 via the oil passage 39 and the check valve 51, and then the high-pressure oil flows into the oil passage 38 via the check valve 50, so that the high-pressure oil is accumulated in the accumulator 200.

Next, when the pressure in the accumulator 200 reaches a certain predetermined value, an electric signal from a pressure sensor 53 is input to the controller 14′, and an electric signal is input to a regenerative valve 203 from the controller 14′ via a signal line C3.

The regenerative valve 203 is a 2-port, 2-position normally closed electromagnetic proportional valve, and is variably switched by receiving an electric signal from the controller 14′ via the signal line C3. When the regenerative valve 203 is switched, the high-pressure oil accumulated in the accumulator 200 is introduced into the oil passage 24-2 through an oil passage 40 diverted from the oil passage 38, the regenerative valve 203, and an oil passage 41 extending from the regenerative valve 203.

In addition, a relief valve 54 is installed in this circuit to prevent oil devices in the circuit from being damaged, by some chance, due to the oil in the circuit becoming blocked and the pressure becoming abnormally high, and the high-pressure oil is discharged into the tank 8 through an oil passage 42 diverted from the oil passage 38, the relief valve 54, and an oil passage 43.

In addition, FIG. 15 illustrates opening characteristics of the switching valve 4 of the second embodiment when the cylinder is extended. In the opening characteristics of the switching valve 4 of the second embodiment, a P-C opening characteristic and a C-T opening characteristic are the same but a P-T opening characteristic is different compared to those of the opening characteristics of the switching valve 4 of the first embodiment illustrated in FIG. 4, and the opening area is smaller than that of a P-T opening of FIG. 4.

Incidentally, in the second embodiment, the reason that the P-T opening is made smaller than the P-T opening of the first embodiment illustrated in FIG. 4 is that, as described above, since in a region where the spool stroke of the switching valve 4 is relatively small, namely, the P-C opening is small, most of the excess oil is caused to flow to the priority circuit via the flow diverter valve device 9, and the oil amount supplied from the main hydraulic pump 2 to the switching valve 4 is reduced, the P-T opening is decreased to that extent to ensure the oil flowing to the hydraulic cylinder 5 via the P-C opening.

The embodiments of the present invention have been described above with reference to the drawings; however, the specific configurations are not limited to the embodiments, and changes or additions that are made without departing from the scope of the present invention are included in the present invention.

For example, the case where the flow diverter valve of the first and second embodiments is an electromagnetic proportional control valve that is switched by the solenoid has been described as an example; however, for example, the flow diverter valve may be a pilot actuation type that is actuated by the pilot pressure supplied from the outside, or the like. In addition, the flow diverter valve may divert and control a constant flow rate through turning on and off an external signal.

In addition, the case where the pressure compensation valve of the first and second embodiments is a pilot valve that operates according to the pilot pressure of the main flow passage and the diverted flow passage has been described as an example; however, for example, the pressure compensation valve may be an electromagnetic proportional control valve that is switched by a solenoid, or the like.

In addition, the mode in which the pressure compensation valve of the first and second embodiments adjusts the opening degree of the main flow passage side and the opening degree of the diverted flow passage side has been provided as an example; however, the pressure compensation valve may adjust only the opening degree of the diverted flow passage side.

In addition, the mode in which the flow diverter valve device of the first and second embodiments is configured such that the housing of the flow diverter valve and the housing of the pressure compensation valve are integrated has been provided as an example; however, the housings may be separately configured.

In addition, the mode in which the flow diverter valve device of the first and second embodiments is configured such that the pressure compensation valve is provided on the downstream side of the flow diverter valve has been provided as an example; however, the pressure compensation valve may be disposed on an upstream side of the flow diverter valve.

In addition, in the first embodiment, the mode in which electricity is generated and stored in the electricity storage device using the excess oil diverted to the diverted flow passage by the flow diverter valve device, the regenerative motor, and the generator, and is used as electric energy has been provided as an example, and in the second embodiment, the mode in which energy can be regenerated by flowing the high-pressure oil to the cylinder using the electromagnetic switching valve, the pressure booster, the accumulator, and the regenerative valve has been provided as an example; however, it goes without saying that the excess oil may be utilized by any means other than the above-described means, using the flow diverter valve device.

### REFERENCE SIGNS LIST

1 Drive mechanism
2 Main hydraulic pump (fluid supply source)
3 Pilot hydraulic pump
4 Switching valve
5 Hydraulic cylinder (actuator device)
8 Tank
9 Flow diverter valve device
10 Regenerative motor (auxiliary machine)
11 Generator (auxiliary machine)
12 Remote control valve
13 Pressure sensor
14, 14′ Controller
24-1 Oil passage (main flow passage)
24-2, 25 Oil passage (flow passage)
27 Oil passage (diverted flow passage)
91 Flow diverter valve
92 Pressure compensation valve
93 Housing
130 Hydraulic circuit (fluid pressure circuit)
200 Accumulator (auxiliary machine)
201 Electromagnetic switching valve
202 Pressure booster (auxiliary machine)
203 Regenerative valve
932, 934 Flow passage (first communication passage)
933, 935 Flow passage (second communication passage)

1. A fluid pressure circuit, comprising:
a fluid supply source;
an actuator device actuated by a fluid from the fluid supply source;
a switching valve provided between the fluid supply source and the actuator device to switch flow passages; and
a flow diverter valve configured to divert at least some of the fluid, which flows from the fluid supply source to a main flow passage included in the flow passages and connected to the switching valve, to a diverted flow passage,
wherein the flow diverter valve is provided with a pressure compensation valve configured to variably adjust an opening degree of the diverted flow passage according to a differential pressure between the main flow passage and the diverted flow passage to compensate for a flow rate to the diverted flow passage.

2. The fluid pressure circuit according to claim 1,
wherein the pressure compensation valve is a pilot valve operated by a pilot pressure of the main flow passage and the diverted flow passage.

3. The fluid pressure circuit according to claim 1,
wherein a housing of the flow diverter valve and a housing of the pressure compensation valve are integrally formed.

4. The fluid pressure circuit according to claim 1,
wherein the flow diverter valve includes the housing provided with a first communication passage communicating a flow passage between the fluid supply source and the flow diverted valve to the main flow passage via the pressure compensation valve, and a second communication passage communicating the flow passage between the fluid supply source and the flow diverted valve to the diverted flow passage via the pressure compensation valve, and a valve body configured to adjust an opening degree of the second communication passage.

5. The fluid pressure circuit according to claim 1
wherein an auxiliary machine actuated by the fluid flowing through the diverted flow passage is provided in the diverted flow passage.

6. The fluid pressure circuit according to claim 2,
wherein an auxiliary machine actuated by the fluid flowing through the diverted flow passage is provided in the diverted flow passage.

7. The fluid pressure circuit according to claim 3,
wherein an auxiliary machine actuated by the fluid flowing through the diverted flow passage is provided in the diverted flow passage.

8. The fluid pressure circuit according to claim 4,
wherein an auxiliary machine actuated by the fluid flowing through the diverted flow passage is provided in the diverted flow passage.
